(19) United States
(12) Patent Application Publication
(10) Pub. No.: US 2008/0320606 A1
(43) Pub. Date: Dec. 25, 2008

(54) Device for interfering with the pirating of movies and artistic mediums

(76) Inventor: Steven Bishop, Mississauga (CA)

Correspondence Address: Elias Borges;Suite 406, 555 Burnhamthorpe Road, Toronto, ON, M9C 2Y3, CA

(21) Appl. No.: 11/819,001

(22) Filed: Jun. 25, 2007

(51) Int. Cl. H04N 5/74; G06F 17/00; H04N 7/167

(52) U.S. Cl. 726/32; 348/164; 380/201

(57) ABSTRACT

The present invention is a system for discouraging the recording of a video image on a video recorder of a movie projected onto a display surface of a translucent movie screen. The system includes a plurality of IR projector lamps mounted behind the movie screen and adjacent to a back surface of the screen opposite the display surface. Each of the projector lamps is adapted and configured to generate an IR beam sufficient strong to transmit through the movie screen with sufficient intensity to create a bright spot of IR light on the display surface corresponding to the position of the IR projectors. The IR projectors are further adapted and configured such that the bright spots of IR light are sufficiently bright to appear clearly on the recorded video image. The IR projectors are releasably coupled to a control module contained in a housing via a plurality of connector elements and electrical lines. The IR projectors are preferably arranged in a grid pattern and the control module is adapted and configured to flash the IR projectors on in off such that a message can be displayed on the grid pattern. The system further includes a plurality of IR transmitting optical fibers coupled to an IR transmitter, the optical fibers being positioned over a display object, the IR transmitter and optical fibers being adapted and configured such that the optical fibers transmit IR ration over the display object.

### FIELD OF THE INVENTION

The invention relates generally to devices for preventing the creation of pirate copies of artwork, photographs, posters, signs, cards, sculptures, and movies displayed on a movie screen.

### BACKGROUND OF THE INVENTION

Shortly after the advent of portable hand held video recorders, the video tape copying of motion picture movies has become a serious problem. Due to their small size and improved low light capabilities, making illegal copies of motion pictures has become quite simple. A person wishing to make an illegal copy (pirate copy) of movie would simply attend at a movie theater where a motion picture would be playing with a portable hand held video recorder. The video recorder would be concealed in a bag or under a coat in order to permit the person to enter the movie theater unchallenged. The user would then simply purchase a ticket and take a seat in the theater. When the lights were down, the user would then simply employ the video recorder to videotape the movie on the screen. The resulting copy, while of poor quality, could then be used to make pirate copies of the movie on VHS tape and DVD.

Despite the poor quality of these pirated movies, the loss of revenue resulting from the sale of these pirated movies has become a serious concern to movie makers. As a result, attempts have been made to make it more difficult to video tape or video record movies shown in a theater. To this end, various systems have been applied with less than perfect results. For example, U.S. Pat. No. 6,559,883 to Fancher and U.S. Pat. No. 7,170,577 to Sitrick disclose the use of infra-red projectors to project a strong beam of infra-red light on to the movie screen in an attempt to degrade the quality of the video image recorded by a portable video recorder to such a point that it would be unlikely that the video made would be reproduced for resale. The principle behind these patents rests on the fact that video recorders are sensitive to IR radiation, hence a strong beam of IR radiation projected on the movie screen, while invisible to the audience, may overwhelm the video recorder producing a recording which appears to be washed out.

While the principle behind this method of piracy deterrence is sound, the intensity of the IR beams needed to render a video recorder unuseable is significant. IR lasers are certainly capable of producing a pattern of IR radiation on the screen with sufficient intensity to overwhelm a video recorder; however, such lasers cannot legally be used because of the serious possibility of incurring serious eye injuries to the audience. As a result, these methods, while basically sound, have limited applicability. An improved system for interfering with the video recording of images on movie screens is therefore required.

### SUMMARY OF THE INVENTION

In accordance with one aspect of the present invention, there is provided a system for discouraging the recording of a video image on a video recorder of a movie projected onto a display surface of a translucent movie screen. The system includes a plurality of IR projector lamps mounted behind the movie screen and adjacent to a back surface of the screen opposite the display surface. Each of the projector lamps are adapted and configured to generate an IR beam sufficient to transmit through the movie screen with sufficient intensity to create a bright spot of IR light on the display surface corresponding to the position of the IR projectors. The IR projectors are further adapted and configured such that the bright spots of IR light are sufficiently bright to appear clearly on the recorded video image.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a perspective view of a control module and IR projector for use with the present invention.

FIG. 2 is a side view of the system of the present invention showing a plurality of IR projectors mounted behind a translucent movie screen.

FIG. 3 is a perspective view of one aspect of the invention showing a framed picture having a plurality of IR transmitting optic fibers mounted thereon.

FIG. 4 is a front view of a plurality of IR projectors made in accordance with the present invention arranged together in a grid pattern and displaying a message.

In the drawings like characters of reference indicate corresponding parts in the different figures.

### DETAILED DESCRIPTION OF THE INVENTION

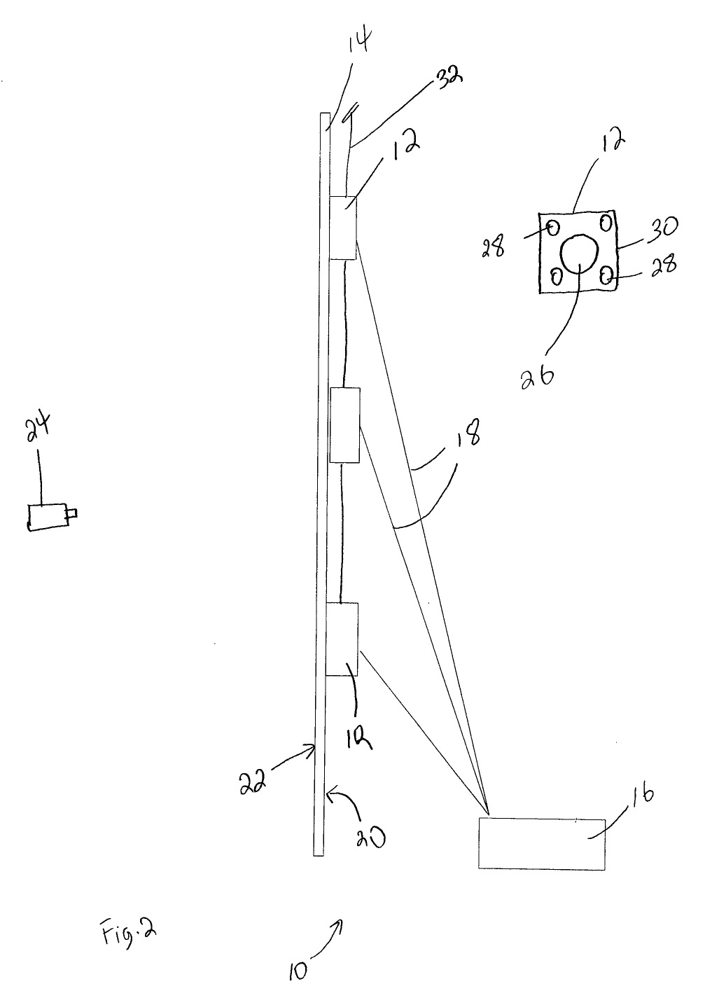

Referring firstly to FIG. 2, the present invention is a system for discouraging the pirating of movies. The system, shown generally as item 10, includes a plurality of IR transmitters 12 mounted adjacent the rear surface 20 of translucent movie screen 14. IR transmitters 12 each comprise a strong IR lamp which is configured to transmit a beam of IR radiation towards screen 14 with sufficient intensity such that the amount of IR ration which passes through screen 14 and out display surface 22 is intense enough to be clearly recorded by video recorder 24. IR transmitters 12 are positioned against rear surface 20 of movie screen 14 either by a scaffolding or wire harness support 32 or by directly securing transmitters 12 to rear surface 20 by means of attachment pads 28 located on housing 30 of each transmitter. Pads 28 are positioned on housing 30 such that when attached to screen 14, IR lamp 26 is directed towards surface 20. Pads 28 may consist of adhesive pads or hook and loop (Velcro™) fasteners.

Transmitters 12 are operatively coupled to a control module 16 by means of electrical cables 18. Ideally a single control module would control a plurality of transmitters 12; however, each transmitter may be coupled to an individual control module. Control module 16 is adapted and configured to send an electrical signal sufficient to activate transmitters 12 through cables 18. Having a separate control module enables transmitters 12 to be made as light and small as possible, making the transmitters easier to mount to the back of screen 14.

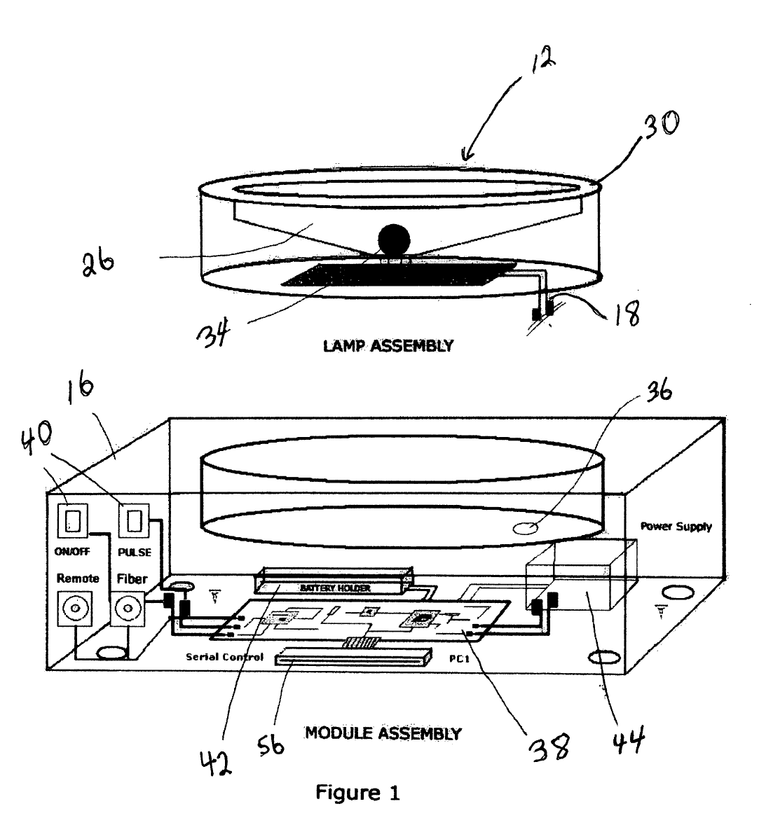

Referring now to FIG. 1, IR transmitter 12 consists of an IR lamp 26 mounted within housing 30. Lamp 26 preferably consists of one or more high intensity IR LED lamps 34 of the type readily available in the marketplace. Lamp 34 is coupled to electrical cable 18 which is in turn releasably coupled to connector element 36 on control module 16. Connector element 36 is in turn coupled to IR LED driver circuit 38. IR LED driver circuit 38 is in turn coupled to control switches 40 which control the operation of the drive circuit. Drive circuit 38 is preferably a solid state LED drive circuit of the type readily available in the market which is selected to send a current through cable 18 of sufficient amperage and voltage to flash LED lamp 34 on at the desired intensity. LED drive circuit may flash LED lamp 34 on and off at a preselected duty cycle, or if desired, keep the LED lamp on for a desired length of time. Drive circuit 38 is also coupled to either battery pack 42 if the device is to be powered by batteries and/or to power supply 44 if the device is to be powered by AC current.

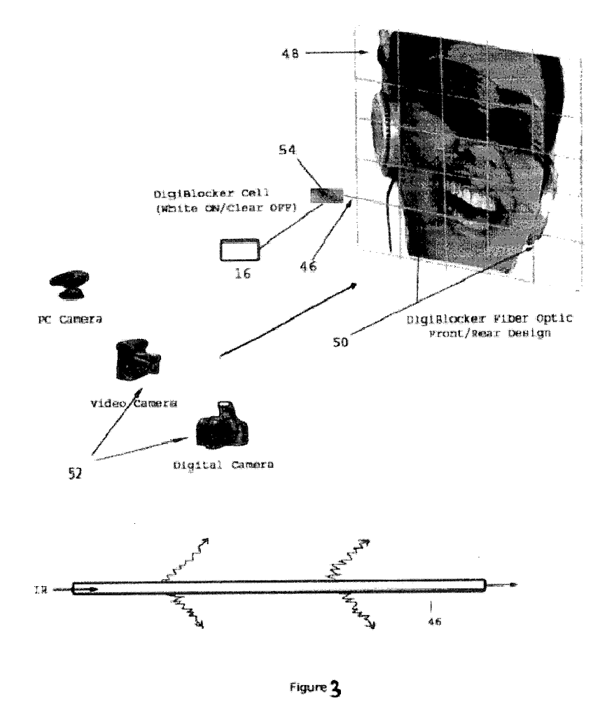

Referring now to FIG. 3, the system of the present invention further includes a fiber optic cable 46 which is operatively coupled to IR transmitter 54 which is in turn coupled to control module 16. Fibre optic cable 46 is draped over display object 48 in a grid pattern 50. Fiber optic cable 46 comprises a fiber optic filament which is adapted and configured to transmit IR radiation through the filament and to release the IR radiation along the length of the filament. Fiber optic cables capable of releasing light from the sides of the cable, referred to as sideglow cables, are readily available in the marketplace from a variety of manufacturers. These sideglow cables are often made of plastic, rather than glass, therefore they are quite capable of propagating IR radiation. IR transmitter 54 is coupled to fibre optic cable 46. IR transmitter 54 is adapted and configured to generate IR radiation at sufficient intensity so that the fibre optic cable glows brightly with IR radiation. In particular, the intensity of the IR radiation generated by transmitter 54 is selected such that the cable glows brightly enough so that the cable will clearly appear in any image taken by cameras 52.

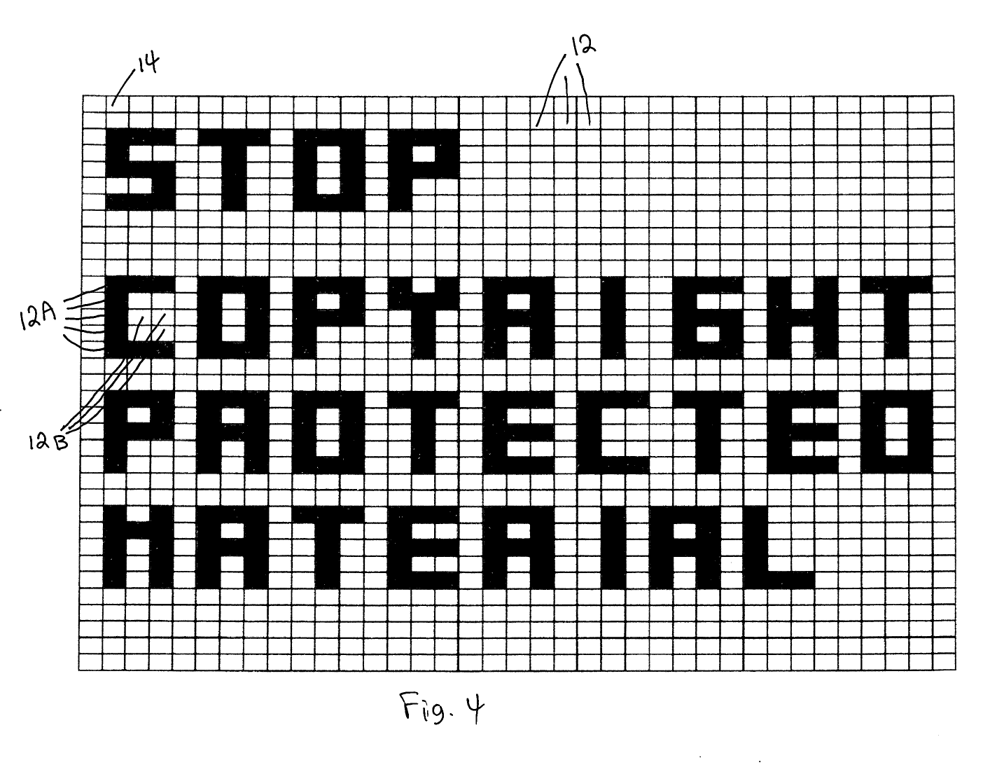

Referring now to FIG. 4, a plurality of IR transmitters 12 can be mounted to screen 14 and arranged in a grid pattern. If sufficient transmitters are included in the grid pattern, messages can be spelled out on the grid by turning transmitters 12 on and off. In the example illustrated in FIG. 4, transmitters 12A are lit up and transmitters 12B are dimmed such that the word FIRE appears on the grid. It will be appreciated that any message or word can be spelled out in the grid given an appropriate number of IR transmitters. Referring back to FIG. 1, control module 16 includes computer interface 56 which is in turn coupled to driver circuit 38. Computer interface 56 can be used to couple the driver circuit to a computer (not shown) to enable a user to control the sequence of flashing transmitters 12.

The present invention has many advantages over the prior art. Firstly, since the IR transmitters are mounted immediately adjacent the movie screen, the IR transmitters can use robust and inexpensive IR LEDs to generate the required intensities of IR radiation. The use of IR lasers is therefore not required. Furthermore, by using sideglow fiber optic cables in association with the system, the system can be used to “copy protect” any display object such as a portrait or sculpture.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A system for discouraging the recording of a video image on a video recorder of a movie projected onto a display surface of a translucent movie screen comprising;
a plurality of IR projector lamps mounted behind the movie screen and adjacent to a back surface of the screen opposite the display surface, each of the projector lamps being adapted and configured to generate an IR beam sufficient to transmit through the movie screen with sufficient intensity to create a bright spot of IR light on the display surface corresponding to the position of the IR projectors, the IR projectors being further adapted and configured such that the bright spots of IR light are sufficiently bright to appear clearly on the recorded video image.

2. The system of claim 1 wherein the IR projector lamps are arranged in a pattern across a center of the movie screen.

3. The system of claim 1 wherein the IR projectors each comprise a plurality of IR LED's, the IR LED's being directed towards the movie screen.

4. The system of claim 1 wherein the IR projectors are each operatively coupled to a control module.

5. The system of claim 4 wherein the IR projector lamps are arranged in a pattern across a center of the movie screen.

6. The system of claim 5 wherein the pattern of IR projector lamps are substantially in the form of a grid pattern, the control module being adapted and configured to flash the IR projector lamps on and off such that a message appears on the grid pattern.

7. The system of claim 4 wherein the control module is housed in a housing, the housing having a plurality of connector elements, each connector element being releasably coupled to an IR projector via an elongated electrical chord.

8. The system of claim 7 further including a plurality of IR transmitting fiber optic filaments, the fiber optic filaments being disposed over a display object, the fiber optic filaments being coupled to a IR transmitter adapted to send IR radiation through the fiber optic filaments, the IR transmitting fiber optic filaments being adapted and configured to leak IR radiation and the IR transmitter being adapted and configured to transmit IR radiation through the fiber optic filament at an intensity such that the display object transmits leaked IR radiation at an intensity sufficient to be clearly recorded by the video recorder.
